(19) United States
(12) Patent Application Publication
(10) Pub. No.: US 2021/0037040 A1
(43) Pub. Date: Feb. 4, 2021

(54) INTELLIGENT SECURITY AUTOMATION AND CONTINUOUS VERIFICATION AND RESPONSE PLATFORM

(71) Applicant: The Toronto-Dominion Bank, Toronto (CA)

(72) Inventors: Nicholas Richard Aleks, Toronto (CA); Daniel Thanos, Burlington (CA); Kelechukwu Kalu Udonsi, Toronto (CA); Joël Perron-Langlois, Montreal (CA); Fahad Ahmed Khan, Milton (CA); Amir Schor, Tel Aviv (IL); Andrew Alexander Micek, Toronto (CA); Darcey MacInnes, Toronto (CA); Ashton Sidhu, Toronto (CA); Jason Rombough, Whitby (KR)

(21) Appl. No.: 16/936,229

(22) Filed: Jul. 22, 2020

Related U.S. Application Data
(60) Provisional application No. 62/879,895, filed on Jul. 29, 2019.

(51) Int. Cl. H04L 29/06; G06N 20/00; G06K 9/62; G06F 11/34

(52) U.S. Cl. CPC H04L 63/1433; H04L 63/205; G06F 11/3452; G06K 9/6256; G06N 20/00

(57) ABSTRACT

A security testing platform can provide security teams with an extensible, cost-effective and flexible platform which can continuously test, evaluate and tune deployed security tools & policies. The security testing platform allows users to automatically simulate security threat attacks in order to measure the effectiveness of a security stack's prevention, detection and mitigation capabilities. A set of endpoints within the controlled environment may be configured to simulate the environment of the application being tested, which may be configured across multiple endpoints. Additional endpoints may also be configured as ‘attackers’ to orchestrate security attacks on the simulated environment. The security testing platform 100 may also integrate monitoring tools to gain automated insights into the detection, reliability and performance capabilities of the current security policies, rules and configurations.

### CROSS REFERENCE TO RELATED APPLICATIONS

This application claims the benefit of U.S. Provisional Application No. 62/879,895, filed Jul. 29, 2019, which is incorporated by reference in its entirety.

### BACKGROUND

Most large enterprises typically report having between 30 to 70 different security vendors. In these types of environments, the security posture of the enterprise can change every day, especially where security tools provided by vendors are constantly changing as vendors adopt the cloud and push updates to address the evolving threat landscape. Small configuration changes within security tooling may inadvertently impact security effectiveness, performance and reliability of the entire organization's infrastructure. In addition, the application or service being tested by the security tools may itself be revised and testing a live operating environment of the application may risk uptime and other challenges to the operating environment. Hence, the need for continuous security monitoring and quality assurance testing in such environments. However, many enterprise security teams do not have the time or skills to recognize the need for constant product testing or to create and execute effective tests.

### SUMMARY

This disclosure relates to an automated security testing platform that may be used for continuous testing, evaluation and tuning of security tools & policies for computing applications and services. The security testing platform can provide security teams with an extensible, cost-effective and flexible platform in which they can operate with agility to continuously test, evaluate and tune the security tools & policies for deployed computing applications and services.

The security testing platform allows users to automatically simulate security threat attacks (such as MITRE ATT&CK tests) in order to measure the effectiveness of a security stack's prevention, detection and mitigation capabilities. The platform has over a hundred-different, non-destructive configurable tests that can be executed within a playbook to simulate real-world threats on networks and endpoints within a controlled environment of endpoints configured and orchestrated by the security testing platform. A set of endpoints within the controlled environment may be configured to simulate the environment of the application being tested, which may be configured across multiple endpoints. Additional endpoints may also be configured as ‘attackers’ to orchestrate security attacks on the simulated environment.

The security testing platform orchestrates tests in delegated units of work (known as stages) to registered endpoints according to their roles (i.e. attacker, target, webserver, domain controller, etc.). Because the security testing platform controls every endpoint and network involved with the test (and thus can coordinate the simulated application environment and attacks thereon), problems identified with the application in the simulated environment can be expected to exist in a live application (e.g. and is not a false positive due to other conditions). The security testing platform 100 may also integrate monitoring tools to gain automated insights into the detection, reliability and performance capabilities of the current security policies, rules and configurations.

The security testing platform provides an immense value in being able to identify security control gaps, automate the continuous monitoring of security tools, train incident response teams on realistic scenarios, allow for the reliable triggers of alerts, validate test results and safe endpoint restoration to achieve idempotent testing without causing unforeseen system damages.

### BRIEF DESCRIPTION OF THE DRAWINGS

FIG. 1 illustrates an example environment in which a security testing platform operates and an example architecture for the security testing platform, according to one embodiment.

FIG. 2 illustrates example components of an endpoint configured by the security testing platform, according to one embodiment.

FIG. 3 illustrates example components of a security testing platform used for automated attack and detection rule generation, according to an embodiment.

FIG. 4 is a flowchart illustrating a process of using machine learning to generate security rules to detect attacks, according to one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

The figures use like reference numerals to identify like elements. A letter after a reference numeral, such as “120A,” indicates the text refers specifically to the element having that particular reference numeral. A reference numeral in the text without a following letter, such as “120,” refers to any or all of the elements in the figures bearing that reference numeral (e.g., “120” in the text refers to reference numerals “120A,” “120B,” and “120C” in the figures).

### DETAILED DESCRIPTION

### Architecture Overview

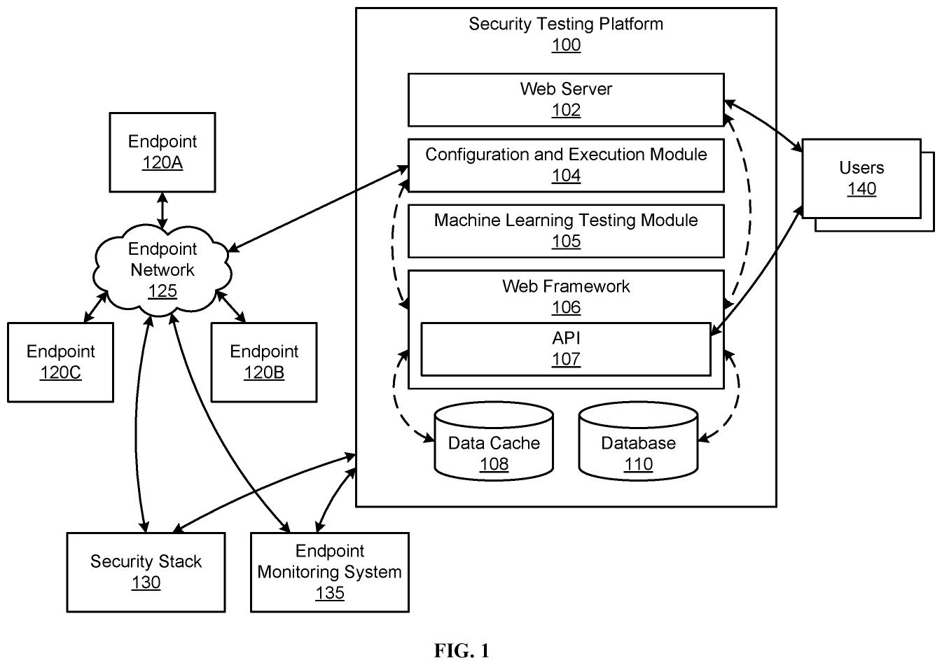

FIG. 1 illustrates an example environment in which a security testing platform operates and an example architecture for the security testing platform, according to one embodiment. The environment of FIG. 1 includes a security testing platform 100, a set of endpoints 120, an endpoint network 125, a security stack 130, an endpoint monitoring system 135, and a set of users 140 of the security testing platform.

The security testing platform 100 of FIG. 1 can design and deploy a set of configurations to endpoints 120 for executing security tests. For example, the security testing platform 100 can design endpoint configurations which implement components of a tested system configuration for one set of endpoints 120 and configurations for executing attempted security attacks on the tested system configuration for another set of endpoints. In some implementations, the security testing platform 100 configures endpoints 120 to interact with other endpoints 120 in a manner simulating a current (live) deployment of the target application or system to be tested (outside of the security test environment of the security testing platform 100). The security testing platform 100 may thus orchestrate security testing while maintaining fidelity to the in practice operating environment of target applications and the kind of attacks that malicious actors may employ when the target application is in a live deployment. In some embodiments, the security testing platform 100 is a computing system (or set of connected computing systems) including one or more computing devices such as servers, server clusters, or personal computing devices (such as laptops, desktop computers, smartphones, or the like). Computing devices of the security testing platform 100 can be local to each other or may be connected through a wired or wireless network (such as the internet). The security testing platform 100 will be discussed further below.

An endpoint of the set of endpoints 120 can be a computing system that configured by the security testing platform 100 to simulate a test environment for performing security tests. Each endpoint provides an interface or application of the computing system that may be accessed (or attacked) by other systems, thus presenting potential security vulnerabilities. For example, an endpoint 120 can be configured to include a test deployment or configuration of a target application or to perform one or more attacks on instances of the target application running on other endpoints 120. In some implementations, individual endpoints 120 can be configured in a variety of roles in the security test, including target and attacker (adversary). An endpoint can be a test server, server cluster, personal computing device (such as a laptop, desktop, or smartphone), virtual machine, or other computing system that can be configured by the security testing platform 100 to interact with other endpoints 120 for performing one or more security tests. The embodiment of FIG. 1 shows three endpoints 120 (120A, 120B, and 120C) for ease of explanation, other implementations of a security testing platform 100 can interact with many more endpoints 120.

In some implementations, the endpoints 120 are connected to each other and the security testing system 100 via endpoint network 125. The endpoint network 125 can facilitate communication among the endpoints 120, the security testing platform 100, and other connected entities. The endpoint network can include any combination of local area and/or wide area networks, using both wired and/or wireless communication systems. In one embodiment, the network 125 uses standard communications technologies and/or protocols. For example, the network 125 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 125 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 125 may be represented using any suitable format, such as hypertext markup language (HTML) or extensible markup language (XML). In some embodiments, all or some of the communication links of the network 125 may be encrypted using any suitable technique or techniques.

In some embodiments, the security stack 130 includes deployments of one or more security protocols, systems, or vendor product forming part of the security environment being tested. The security stack 130 can include facilities for the prevention, detection, and mitigation of attacks. The security stack 130 can be configured by the security system 100 (for example, to implement one or more security policies) and can interact with the endpoints 120 (for example to provide security services to one or more endpoints 120 under a simulated attack). In some implementations, the security stack 130 mirrors the deployments of security services and products in a live or potential deployment of the product to be tested.

The endpoint monitoring system 135 can monitor performance statistics (such as CPU and memory usage) or other telemetry data of the endpoints 120 and report the resulting statistics to the security testing platform 100 for use in evaluation of a tested security configuration. In some implementations, the endpoint monitoring system 135 is a security information and event management (STEM) solution to monitor the endpoints 120. A STEM is a security information and event management system and may include a set of configuration rules to prevent and detect malicious actions at an endpoint. The endpoint monitoring system 135 may be a component of the security testing platform 100 or may be a separate system or platform that receives endpoint 120 and network data and applies security controls (e.g., security rules) thereto. The particular rules implemented by the endpoint monitoring system may be one aspect of a security configuration tested by the security testing platform 100 (i.e. the endpoint monitoring system 135 can be configured by the security testing platform 100 as part of the tested security stack 130).

The security testing platform 100 can interface with one or more users 140 to provide feedback data, receive additional test applications and/or configurations to test, and the like. Users 140 can communicate with the security testing platform 100 via a client device, a web interface of the security testing platform, or an API provided by the security testing platform 100.

In the embodiment of FIG. 1, the security testing platform 100 includes a web server 102, a configuration and execution module 104, a machine learning testing module 105, a web framework 106 including an API 107, a data cache 108, and a database 110. In other embodiments, the security testing platform 100 may include additional, fewer, or different components for various applications and may operate in an environment with additional, fewer, or different components. Conventional components such as network interfaces, security functions, load balancers, failover servers, management and network operations consoles, and the like are not shown so as to not obscure the details of the system architecture.

In the embodiment of FIG. 1, the web server 102 is a high-performance web server deployed as a frontend for the security testing platform 100. The web server 102 can handle web-socket and http requests directed to the security testing platform. For example, users 140 of the security testing platform can communicate instructions and/or receive test results and collected data via the web server 102. The web server 102 may be implemented in Nginx or another suitable web server solution, which may provide proxying or reverse proxying, load balancing, and other web server functions for the security testing platform 100.

The data cache 108 is an in-memory key-value data cache used to store temporary data for or received from endpoints, according to some embodiments. For example, the endpoints 120 may report data such as memory, CPU, and process metrics to the security testing platform 100 during execution of the simulated security attacks which can then be stored in the data cache 108 as they are received. Some or all information initially stored in the data cache 108 can eventually be moved to the database 110 for long-term storage. In some embodiments, the security testing platform 100 (and the data cache 108) may be distributed across multiple computing systems, such that the data cache 108 is distributed among them. The data cache 108 may be implemented with Redis as an in-memory data structure and implement a distributed memory key-value database to store received data.

The database 110 can function as the core long-term data storage for the security testing platform 100. The database 110 can hold information on reports, attacks, endpoint configurations, and models within the security testing platform 100. The database 110 may be implemented as an object-relational database, such as PostgreSQL.

The web framework 106 can provide a communication mechanism between components of the security testing platform 100. For example, the web framework 106 can use a Python-based web framework (such as Django) which follows the model-view template architectural pattern. The security testing platform 100 backend models can be defined in the web framework 106 and migrated into the database 110 for storage. In some implementations, the web framework 106 implements an API 107 (for example, a REST API) and/or channels for communication between components of the security testing platform 100, or between the security testing platform 100 and users 140 of the security testing platform 100. As discussed below, the web framework 106 may also receive security information events directly from endpoints 120 or from the endpoint monitoring system 135. The web framework 106 may provide for effective cross-platform communication between the security testing platform 100 and the set of endpoints 120 (which may include endpoints 120 having different operating systems and/or system configurations).

The configuration and execution module 104 can configure endpoints 120 to perform assigned roles in a security test and manage the set of endpoints 120 during the performance of the security test. For example, the configuration and execution module 104 may orchestrate a configuration where a first endpoint 120A simulates components of a target application while another endpoint 120B performs simulated breach attacks to test the security of the target application (and/or one or more security protocols of the security stack 130). The configuration and execution module 104 can maintain configuration data for deploying and controlling the configurations of endpoints 120 to perform a set of security tests on a security configuration. In one embodiment, the configuration and execution module 104 is implemented using SaltStack. SaltStack is a Python-based open-source configuration management software and remote execution technology. In other embodiments, other configuration management tools and technologies may be used as the configuration and execution module 104, such as Ansible. SaltStack implements a concept known as Infrastructure-as-Code which is the process of managing and provisioning computers through machine-readable definition files; rather than physical hardware configuration or interactive tools. The configuration and execution module 104 may also thus provide an abstraction layer between the individual endpoints 120, which may have various hardware and software configurations, and the definition of the desired configuration of an endpoint 120 in a security test or security configuration, which may be expressed in a markup language such as YAML that describes the infrastructure configuration as code. In one embodiment, the configuration and execution module 104 uses a master-minion design principal, such that a master service of the configuration and execution module 104 is part of the security testing platform 100 while the endpoints 120 each run an agent of the configuration and execution module 104.

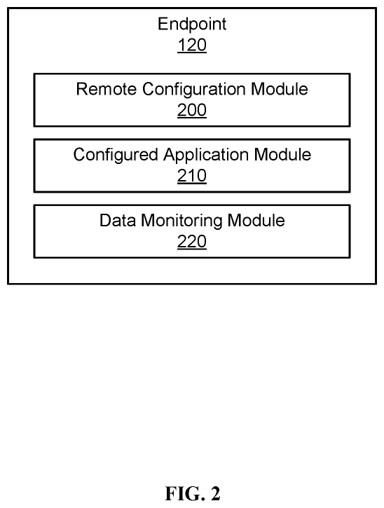

FIG. 2 illustrates components of an endpoint 120 according to one embodiment. The endpoint 120 of FIG. 2 includes a remote configuration module 200, a configured application module 210, and a data monitoring module 220. Other endpoints 120 can include additional or different modules (for example, depending on their assigned role and configuration).

In this example, the remote configuration module 200 on the endpoint 120 operates as the agent (minion) of the configuration and execution module 104. In other embodiments, the remote configuration module 200 in the endpoints 120 may not run as an agent of the configuration and execution module 104, for example in embodiments where configuration and execution module 104 leverages agent-less remote authenticated execution and configuration on targeted endpoints 120. In embodiments where the configuration and execution module 104 uses SaltStack, the remote configuration module 200 of an endpoint 120 may be implemented as a salt-agent.

In some implementations, the endpoint 120 first installs the remote configuration module 200 (for example, from the security testing platform 100) and the remote configuration module 200 subsequently installs and configures a configured application module 210 and data monitoring module 220. In some implementations, endpoints 120 connect with the security testing platform 100 by installing the remote configuration module 200 (e.g., a salt-minion agent) and setting an address for retrieving configuration settings as an address of the configuration and execution module 104 (e.g., a salt-master address of the configuration and execution module). The remote configuration module 200 may then gather information about the underlying endpoint 120 (e.g., its operating system, hardware configuration, etc.) and send its information to the security testing platform 100 for registration and addition to the set of endpoints 120 managed by the security testing platform 100. The configuration and execution module 104 may then assign a role to the endpoint 120 and transmit a configuration for the configured application module 210 on the endpoint 120 along with data monitoring instructions for the data monitoring module 220. In some embodiments, an authenticated user 140 of the security testing platform 100 assigns a role to the endpoint, while in other embodiments the role may be automatically determined based on the characteristics of the endpoint 120 (for example, the hardware of the endpoint 120) and/or the assigned roles of other endpoints 120.

### Endpoint Role Management

The role-based orchestration of the security testing platform 100 allows for automating various kill-chain simulations, remote and local based attacks, lateral movement and living-off-the-land attacks to be executed by endpoints 120 operating as attackers targeting endpoints 120 operating as the target application, or in other roles simulating an environment in which the target application is deployed. In some embodiments, roles are established on endpoints 120 through the remote configuration module 200 via the configuration and execution module 104. In one embodiment, configurations are implemented on endpoints 120 as salt-minion configuration files. In this example, the characteristics of the endpoint 120, such as the operating system, domain name, IP address, kernel, OS type, memory and many other system properties may be used to characterize a given endpoint 120 and “image” the endpoint 120 based on its characteristics. Thus, the individual assigned roles may not require individual identifiers of the endpoint 120 and may be assigned based on the combination of system characteristics that characterize the particular endpoint 120. In the SaltStack implementation, this configuration data, along with a particular state or other data associated with the endpoint 120 may be termed “grains.”

Table 1 shows example roles assignable by the security testing platform 100 to endpoints 120. In various embodiments, these roles can be set in the grains file manually, or can be remotely added using images run from a state file from the salt-master in a infrastructure/[name of role state]' directory. In some implementations, a state file will automatically set the role grain of the endpoint 120 to the selected image while also downloading/provisioning the endpoint 120 with all the configurations for that role.

TABLE 1
Role Rules

| Image | Role Name | Description |
|---|---|---|
| Attacker | attacker | Remote attacker endpoint typically |
| | | outfitted with hacking utilities and |
| | | tools |
| Target | target/null | Machine that receives the attack and |
| | | executing the payload/attacks. This |
| | | is the endpoint that is typically |
| | | protected by the security tool and |
| | | application being tested. |
| Domain | domain- | A server that hosts an Active Directory |
| Controller | controller | environment. |

The target role represents an implementation of the configured application to be deployed to the configured application module 210. The configured application can include further components, software, and other modules for implementing the application or service to be tested or attacked during the security test. A configured application deployed to the configured application module 210 can include various security tools and configurations, such as security policies and other related configurations designed for protecting the operation of the application. For example, security policies of the configured application may include settings or procedures for logging users in, granting particular access rights, maintaining security of session accesses, managing session handoff among various systems, database security access, and so forth. In general, the application and these security settings are the targets of the security attacks to be executed by other endpoints 120. Such attacks may attempt to exceed expected access rights, identify vulnerabilities in accessible ports, exploit database accesses, and so forth, as discussed below.

### Anatomy of an Attack

In some implementations, the configuration and execution module 104 stores and coordinates a library of automated attacks which can be used during security tests. In some embodiments, the configuration for executing an attack is written in a configuration for deployment to an endpoint 120 having an attacker role. For example, when using SaltStack, the configuration may be salt state files, which contain both declarative and imperative instructions for the salt-minions (i.e., the remote configuration module 200) to execute at the configured application module 210.

Orchestration of an automated attack may follow a particular sequence. In some embodiments, an authenticated user 140 submits a request through the web server 102 with all the prerequisites necessary for the attack test. The web server 102 then provides, through the web framework 106, the attack configuration files (e.g., salt-state files), variable data, as well as an identification of which endpoints 120 (e.g., salt-minions) to execute the attack test on.

The attack may then be executed by an endpoint 120 according to the sequence, each of which may be implemented by individual configurations of the endpoint 120. In a SaltStack implementation, each attack may be implemented by a salt state file that is interpreted by the salt-minion and executed consecutively on the ‘attacker’ endpoints 120. In some embodiments, specific configurations for an attack may also be applied to the endpoints 120 having different roles, such as the target, for example, for an endpoint 120 with a target role to set up, analyze, or clean up from the simulated attack.

In some embodiments, an attack sequence includes four steps or “stages.” Stages allow for the logical separation of portions of an attack and follow a standard order: Configuration, Attack, Validation and Clean-up as shown in Table 2: Stages of an Attack Test. During execution of each of these stages on the endpoint 120, the remote configuration module 200 sends the results back to salt-master configuration and execution module 104 where it is parsed and sent to the web framework 106 for reporting and the database 110 for storage.

TABLE 2
Stages of an Attack Test

| Stage | State File | Description |
|---|---|---|
| Configura- | config.sls | First stage, configures both the target |
| tion | | and attacker endpoints 120 with the correct |
| | | files, payloads, programs and configura- |
| | | tions needed to execute the attack. |
| | | (for example, an attacker endpoint 120 may |
| | | setup a tcp listener, and a target endpoint |
| | | 120 may download a reverse tcp binary/ |
| | | script) |
| Attack | attack.sls | Second stage, also known as the “execution |
| | | stage,” where the attack occurs. |
| | | (for example, during this stage payloads |
| | | detonate, scripts execute, tools run, etc.) |
| Validation | validate.sls | Third stage, identifies the results of an |
| | | attack. Known post-conditions with expected |
| | | outcomes are tested to determine whether |
| | | the attack was prevented. |
| | | (for example, endpoints 120 parse attack |
| | | output files) |
| Clean-up | clean.sls | Final stage of the attack, allows the test |
| | | as a whole to be idempotent. This stage |
| | | removes any artifacts and residual effects |
| | | on endpoints 120 resulting from the test |
| | | attack, such as payloads, configurations, |
| | | tools and/or files generated during the |
| | | previous 3 stages. |

During an attack, the assigned role of an endpoint 120 determines which action it will take, allowing the security testing platform 100 to manage the complexities of orchestrating multi-vector remote attacks. In some implementations, instructions for performing the attack are separated based on role and role is used to determine which instructions are followed by each endpoint 120 during each of the four stages of an attack. For example, during the Configuration stage of a reverse tcp shell attack, an endpoint 120 with the “attacker” role needs to listen on a particular port, while a machine with the “target” role needs to download a reverse tcp binary or script. In some embodiments, a single configuration stage file contains instructions for multiple endpoints 120 or endpoint roles (for example, for both the “attacker” and “target” roles) and an endpoint 120 can select the correct instructions to perform based on its assigned role. In the SaltStack embodiment, this configuration file may be YAML and include furthermore may include conditional statements using “grains[kernel]” to instruct a tailored behavior across multiple OS types. An example portion of such a configuration file is provided:

Snippet of config.sls

. . .
# Attacker configuration steps
{% if grains[‘role’] == ‘attacker’ %}

listen:

cmd.script:

- name: salt://[. . .]/reverse-shell-connection/files/listen.sh
- template: jinja
- context:

port: {{port}}

# Target Configuration steps
{% elif grains[‘role’] == ‘target’ %}

{% elif grains[‘kernel’] == ‘Windows’ %}

get-payload:

file.managed:

- name: C:\files\nc.exe
- source: salt://attack/software/nc-win/nc.exe
- makedirs: True

. . .

As shown, the assigned role of an endpoint 120 may be used by the endpoint 120 to determine its appropriate behavior during an attack. Further, if a single configuration file is used to trigger actions across multiple roles, a user 140, engineer, or developer preparing or reviewing the configuration file may reference a single document to verify that the configuration appropriately performs the expected behaviors across the orchestrated endpoints 120. Likewise, a single configuration file for the attack may be distributed across the set of endpoints 120 to perform for the attack. In addition, endpoints 120 defined by a role within the security testing platform 100 can also share data with each other utilizing a shared data cache 108, or for example via a SaltStack Mine (in a SaltStack implementation). Below is an example of a network service scan attack file. In this implementation, the endpoint 120 in the “attacker” role can set the target ip variable by pulling information from the salt-mine about the target endpoint 120.

Snippet of attack.sls

. . .
{% set target_ip = salt[‘mine.get’](target, ‘network.ip_addrs’) %}

scan-step:

cmd.run:

- name: “nmap {{target_ip}} -p {{target_port}} -oG /tmp/out.txt”

. . .

In some implementations, the security testing platform 100 can automatically generate new attack configurations and security configurations for tests using the machine learning testing module 105. For example, the machine learning testing module 105 can generate attack configurations to be executed by attacker role endpoints 120 during a simulated attack. These attack configurations can be generated by machine learning computer models that predict possible attack vectors for given target applications and related configurations of the application or security settings. For example, the machine learning models may be trained to generate variations in the particular security attacks or parameters used by those attacks according to previously programmed attacks (for example as generated by users 140). In other embodiments, the attack generation machine learning models are trained to generate additional attack configurations for particular target applications based on the attack configurations that revealed vulnerabilities in target applications.

Similarly, the machine learning testing module 105 can use machine-learned models to generate security configurations or policies to cure vulnerabilities revealed by the test attacks. For example, prior security vulnerabilities and the policies implemented to cure those vulnerabilities may be used as a training set to learn appropriate security policies to apply for a new security vulnerability revealed for a target system or application. The security policy generated by this model may then be used as a suggestion for a user 140 considering an appropriate fix for the vulnerability, or the test may be re-run while using the generated policy to determine whether the proposed policy by the model can be automatically validated to cure the vulnerability. The machine learning testing module 105 will be discussed further below.

### Attack Parameters

In some implementations, attacks performed in the security testing platform 100 contain parameters used to pass target application or endpoint 120 relevant information such as usernames, passwords, domains, or port number to the endpoints 120 performing the attack. The use of attack parameters can allow for dynamic testing, giving users 140 full control over the simulated attack. The security testing platform 100 can allow users 140 to configure attack parameters through the web server 102 user interface or via a REST API with the web framework 106 before test execution. In some embodiments, attack parameters are set through the grains and/or SaltStack pillars, using a JSON key-value format. In some implementations, pillars are not stored on the endpoint 120 salt-minion configuration files and are instead compiled on the master (the configuration and execution module 104). In some embodiments, pillar data for a given endpoint 120 is only accessible by the endpoint 120 for which it is targeted in the pillar configuration. This makes pillar useful for storing sensitive data specific to a particular endpoint 120.

In some embodiments, attack state files pull the salt-pillar parameter data using jinja variables, which can be denoted by curly brackets ({{ }}). Default parameters for an attack are typically set during the creation of an attack and are displayed through the web server 102 UI allowing users 140 to edit them before executing a test. The code below demonstrates how attack parameters are passed from the pillar into the salt state file and then used as execution variables.

Snippet of config.sls

{% set target_account = pillar[‘target_account’] %}
{% set domain = salt.pillar.get(‘target_account:domain’, “.”) %} #If no
domain is set default to “.”
{% set username = pillar[‘target_account’] [‘username’] %}
{% set password = pillar[‘target_account’] [‘password’] %}
. . .

### Realtime Endpoint Telemetry

In some situations, endpoint telemetry (such as CPU and Memory usage) is neglected during security control testing. For example, engineers can focus more attention on the prevention and detection results of the test and the success of the attack rather than the performance, reliability and/or efficiency of the security tools being tested (for example, as measured by endpoint telemetry). Similarly, it can be difficult for security engineers to be able to characterize the idle performance metrics on a network or endpoint 120 with a high degree of accuracy. In some cases, measured endpoint performance impact could be the only distinguishing difference in a comparison test between two competing vendor security tools that are being evaluated (for example, if both security tools effectively stop the simulated attack, but one results in a higher performance impact to the target endpoint 120). Throughout the duration of a test, the security testing platform 100 receives performance snapshots of the endpoint 120 via the data monitoring module 220. In some embodiments, performance snapshots from the data monitoring module 220 are displayed in the final report and gives a user 140 the ability to identify how much CPU/Memory was consumed by the endpoint security tool to detect/prevent a simulated attack.

In some embodiments, the security testing platform 100 includes or interfaces with a cross-platform endpoint monitoring system 135 as described above. The endpoint monitoring system 135 can provide real-time endpoint telemetry viewable by users 140 via the web server 102 and stored as part of the test results within the database 110. During endpoint 120 setup, the security testing platform 100 can install a data monitoring module 220 on the endpoint 120. In some implementations the data monitoring module 220 opens a web-socket connection with the security testing platform 100 or the endpoint monitoring system 135. For example, the data monitoring module 220 can gather CPU, memory, process, and/or system telemetry information and transmits the telemetry data back to the data monitoring module 220 (or the security testing platform 100). The telemetry data collected by the data monitoring module 220 can be used to implement a security information and event management (STEM) solution to monitor the endpoints 120 and implement security protocols or policies. In addition, additional telemetry data may be gathered by additional network devices, security tools, infrastructure, or the like, to provide a complete view of the effect of security tests on the endpoints 120 and simulated environment of the test.

### Security Effectiveness Testing Through Adversary Emulation

The ability of a security product to respond accurately and efficiently to a wide range of common threats as well as to provide comprehensive protection against novel attacks and threats targeting specific applications/servers (as used herein, “security effectiveness”). In some implementations, a security testing platform 100 is used to evaluate the security effectiveness of a security product as well as its impact on legitimate activities (for example, not blocking legitimate activities) or drastically impacting the performance of an endpoint 120.

Security effectiveness can be difficult to evaluate because a thorough evaluation of security effectiveness can require expertise with a variety of attack techniques, including potentially dangerous exploits. The MITRE ATT&CK framework provides a curated knowledge base and model for cyber adversary behavior, reflecting the various phases of an adversary's lifecycle and the platforms they are known to target. The security testing platform 100 thus provides an approach for adversary emulation that uses techniques that have been publicly attributed to an adversary chained together into a logical series of actions for implementation in security tests.

However, adversary imitation can have limitations, for example, because not all adversary activity is covered in public reporting, emulations will only cover a portion of all adversary activity. Similarly, threat reporting necessarily covers mainly past adversary activity due to delays in the reporting cycle and availability of information. Therefore, when emulating an adversary, typically only historical behavior may be explicitly programmed based on historical or otherwise publicly available adversary activity.

### Automated Unit-Testing of Adversary Techniques and Behaviors

In some implementations, users 140 emulating an adversary via the security testing platform 100 generally do not manually execute the actual adversary tools; instead, they attempt to script the technique as closely as possible using publicly-available tools and threat intelligence reports to develop an “as close as possible” an automated attack that unit tests the adversary's behavior (for example, as a configuration for performance by an “attacker” role endpoint 120).

To perform a security test using automated adversary behaviors, unit-tests can be performed together in a logical flow (herein, a “playbook”). For example, an adversary must discover that a host exists before they can move laterally to that host, resulting in a unit-test for discovering the host chained to a unit-test for a lateral move to the host. In a live attack by a real adversary, the adversary may not execute atomic actions as broken up into unit-tests or may execute one of hundreds of variations of an attack technique. However, the use of unit-tests can provide a model for the security testing platform 100 to model an adversary attack and response of a security tool to various stages of the attack. The security testing platform 100 may also include configurable pauses between playbook tests for pacing. In some implementations, pacing for how quickly we execute ATT&CK techniques is also important for evaluations. The techniques must be separable so we can identify distinct detection's in vendor capabilities. Therefore, unit-tests for individual attack techniques may be organized into “attack unit-tests” or “attack tests” for short. In some implementations, vendors of security tools build capabilities to address the real threats, which might include specific patterns or time constraints.

As described above, the machine learning testing module 105 can automatically generate new attack configurations and security configurations performing security tests. The machine learning testing module 105 uses machine learning to automate the generation of attacks and the rules for detecting such attacks. For example, the machine learning testing module 105 can use the generative capabilities of generative adversarial networks (GANs) to produce artificially generated attacks to evade detection and as a result, enhance the detection of the security system once additional policies are created to detect the artificial attacks. Machine learning models trained by the machine learning testing module 105 can be used to generate, or output, new data based on training data of attacks and (effective or ineffective) responses to those attacks in the original dataset. Trained GANs may be used for attack generation against intrusion detection with the generated attacks almost fully evading detection with existing security policies.

The security testing platform 100 can automate creation of new attacks by running its automated attacks on endpoints that are configured to send their endpoint telemetry for monitoring and analysis, for example to a system applying various security controls, such as SIEM. A STEM is a security information and event management system and may include a set of configuration rules to prevent and detect malicious actions at an endpoint. The STEM may be a component of the security testing platform 100 or may be a separate system or platform that receives endpoint and network data and applies security controls (e.g., security rules) thereto. The particular rules implemented by the security control may be one aspect tested by the security testing platform 100, and the automated attacks may be used to test and attempt to exploit the current security controls. When exploited, the security controls may be modified to account for the successful attack.

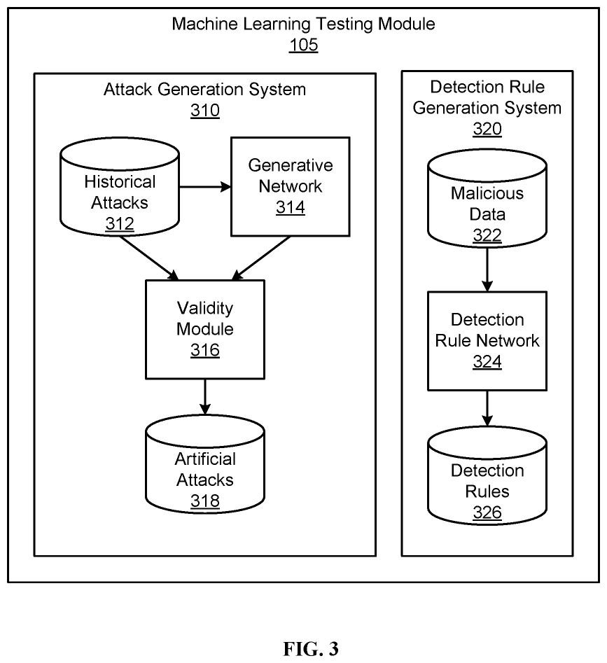

FIG. 3 illustrates example components of a security testing platform used for automated attack and detection rule generation, according to an embodiment. The machine learning testing module 105 of FIG. 3 includes an attack generation system 310 and a detection rule generation system 320.

The attack generation system 310 of the machine learning testing module 105 can use a generative network 314 new artificial attacks for testing. In some implementations, the generative network 314 uses one or more GANs (or other machine learning models) to create permutations of the historical (existing) attacks 312 to create new artificial attacks for testing. In some implementations, the machine learning testing module 105 or generative network 314 uses neural networks to generate entirely new attacks or variations of existing attacks.

The validity module 316 can then test the artificial attacks generated by the generative network 314 against existing security controls (for example of the security stack 130) and, if the artificial attack successfully evades detection, a new attack has been created. Similarly, an artificial attack can be tested for validity (whether the permutated attack can be performed in practice) and detection (is this attack malicious and functional), for example using the security testing platform 100. If an artificial attack passes both tests, a new attack permutation has been created and can be stored as an artificial attack 318 and, for example, used by the security testing platform 100 to evaluate security tools or security tool combinations.

The detection rule generation system 320 of the machine learning testing module 105 can use a similar approach to generate security policies and controls to detect and prevent attacks (including new artificial attacks). In some implementations, the detection rule generation system 320 utilizes machine learning algorithms that parse malicious data 322 (for example, data received or collected by a target endpoint 120 as part of an attack) as well as detection methods (such as those described by frameworks such as MITRE and OPENC2) to create detection rules. The detection rule network 324 can include machine learning models using algorithms such as GANs, Ensemble Methods, and Regularization to transform malicious data into a rule for detecting the malicious data. In some implementations, malicious data 322 that bypasses detection by any means (for example malicious data from an artificially generated attack, an attack simulations, or a real attacks) can be used as training data for the detection rule network 324 to generate more finely tuned detection rules 326. For example, the gathered malicious data 322 can be used to create detection rules that evaluate data available to the security stack 130 (or a target endpoint 120) and generate an alert if trigger conditions are met. Data evaluated by a detection rule can be any data generated by an endpoint 120, security tool, or the link, such as log data, network data, packet data, or telemetry data. In some implementations, the attack generation system 310 and the detection rule generation system 320 can work in tandem to create an autonomous adversarial network which generates artificial attacks and the security rules to detect them.

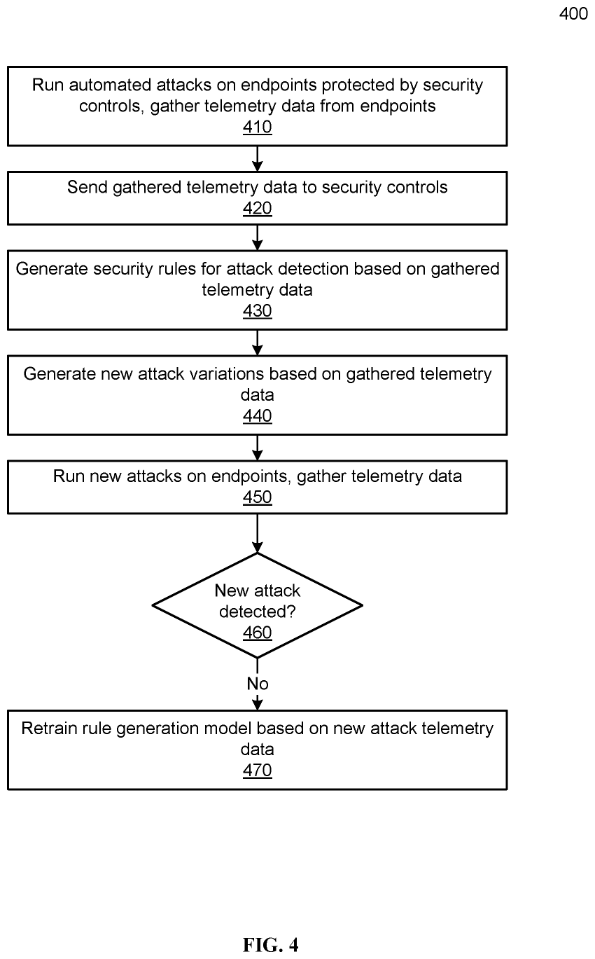

FIG. 4 is a flowchart illustrating a process of using machine learning to generate security rules to detect attacks, according to one embodiment. The process 400 of FIG. 4 begins when automated attacks are run 410 from the security testing platform 100 are run on endpoints 120 (and the security stack 130). Telemetry data is gathered 420 from the endpoints 120 and sent to the security controls (for example, the security stack 130) for potential detection of the attack. Then new security rules for attack generation are generated 430 based on the gathered telemetry data. For example, attack data can be input into machine learning models of the detection rule generation system 320 to generate security rules for detecting attack techniques. Similarly, the gathered telemetry data or output of the security controls in detecting the attack can be used to generate 440 new attack variations. For example, attack data can be input into machine learning models of the attack generation system 310 to generate new attack permutations. The new attacks can be run 450 from the security testing platform 100 are run on endpoints 120 (and the security stack 130 with updated detection rules). If the new attack evaded detection 460, the security rule generation model (for example, of the detection rule generation system 320) can be retrained 470 to generate updated detection rules.

### Conclusion

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A system comprising:
a security testing platform configured to:
send, to a set of endpoints, one or more configuration files describing a set of actions which, when executed by endpoints of the set of endpoints, perform a security test comprising a simulated attack;
receive, from one or more endpoints of the set of endpoints, telemetry data captured during the simulated attack; and
generate, based on the telemetry data, updated security rules for detecting the simulated attack and one or more variations of the simulated attack; and
a set of endpoints communicatively connected to the security testing platform, each endpoint of the set of endpoints configured to:
perform one or more actions of the set of action described by the one or more configuration files;
gather telemetry data during the simulated attack; and
send, to the security testing platform, the gathered telemetry data.

2. The system of claim 1, wherein each endpoint of the set of endpoints is assigned a role of a set of roles by the security testing platform and each action of the set of actions is associated with a role of the set of roles.

3. The system of claim 2, wherein one or more endpoints of the set of endpoints is assigned a target role of the set of roles, each endpoint assigned as a target comprising a configured application to be tested by the simulated attack.

4. The system of claim 3, wherein the telemetry data gathered by the one or more endpoints assigned the target role comprises performance statistics of the endpoint.

5. The system of claim 1, further comprising a security stack including one or more security tools configured to mitigate the simulated attack.

6. The system of claim 1, wherein the security testing platform is further configured to:
train a detection rule machine learning model based on the gathered telemetry data, the detection rule machine learning model configured to generate one or more detection rules which, if implemented during the simulated attack, would mitigate the simulated attack;
use the detection rule machine learning model to generate one or more updated detection rules;
train an attack generation machine learning model based on the gathered telemetry data, the attack generation machine learning model configured to generate one or more variant attacks distinct from the simulated attack; and
use the attack generation machine learning model to generate a variant attack.

7. The system of claim 6, wherein one or more endpoints of the set of endpoints are further configured to perform one or more actions of an updated set of actions which, when executed by endpoints of the set of endpoints, perform a security test comprising the variant attack.

8. The system of claim 6, further comprising a security stack including one or more security tools configured to mitigate the simulated attack and wherein the security testing platform is further configured to apply the updated detection rules to the security stack.

9. A method comprising:
sending, from a security testing platform to a set of endpoints, one or more configuration files, each endpoint of the set of endpoints configured to perform actions of a set of actions described by the configuration files to perform a security test comprising a simulated attack;
receiving, from one or more endpoints of the set of endpoints, telemetry data captured during the simulated attack; and
generating, based on the telemetry data, updated security rules for detecting the simulated attack and one or more variations of the simulated attack.

10. The method of claim 9, wherein each endpoint of the set of endpoints is assigned a role of a set of roles by the security testing platform and each action of the set of actions is associated with a role of the set of roles.

11. The method of claim 10, wherein one or more endpoints of the set of endpoints is assigned a target role of the set of roles, each endpoint assigned as a target comprising a configured application to be tested by the simulated attack.

12. The method of claim 11, wherein the telemetry data comprises performance statistics of an endpoint assigned the target role.

13. The method of claim 9, further comprising:
training a detection rule machine learning model based on the captured telemetry data, the detection rule machine learning model configured to generate one or more detection rules which, if implemented during the simulated attack, would mitigate the simulated attack;
using the detection rule machine learning model to generate one or more updated detection rules;
training an attack generation machine learning model based on the gathered telemetry data, the attack generation machine learning model configured to generate one or more variant attacks distinct from the simulated attack; and
using the attack generation machine learning model to generate a variant attack.

14. The method of claim 13, further comprising sending, from the security testing platform to the set of endpoints, one or more additional configuration files, each endpoint of the set of endpoints configured to perform actions described by the additional configuration files to perform a security test comprising the variant attack.

15. A non-transitory computer-readable storage medium comprising instructions which, when executed by a processor, cause the processor to perform the steps of:
sending, from a security testing platform to a set of endpoints, one or more configuration files, each endpoint of the set of endpoints configured to perform actions of a set of actions described by the configuration files to perform a security test comprising a simulated attack;
receiving, from one or more endpoints of the set of endpoints, telemetry data captured during the simulated attack; and
generating, based on the telemetry data, updated security rules for detecting the simulated attack and one or more variations of the simulated attack.

16. The computer-readable storage medium of claim 15, wherein each endpoint of the set of endpoints is assigned a role of a set of roles by the security testing platform and each action of the set of actions is associated with a role of the set of roles.

17. The computer-readable storage medium of claim 16, wherein one or more endpoints of the set of endpoints is assigned a target role of the set of roles, each endpoint assigned as a target comprising a configured application to be tested by the simulated attack.

18. The computer-readable storage medium of claim 17, wherein the telemetry data comprises performance statistics of an endpoint assigned the target role.

19. The computer-readable storage medium of claim 15, wherein the instructions further comprise steps which, when executed by the processor, cause the processor to perform the steps of:
training a detection rule machine learning model based on the captured telemetry data, the detection rule machine learning model configured to generate one or more detection rules which, if implemented during the simulated attack, would mitigate the simulated attack;
using the detection rule machine learning model to generate one or more updated detection rules;
training an attack generation machine learning model based on the gathered telemetry data, the attack generation machine learning model configured to generate one or more variant attacks distinct from the simulated attack; and
using the attack generation machine learning model to generate a variant attack.

20. The computer-readable storage medium of claim 19, further comprising instructions which, when executed by the processor, cause the processor to perform the step of sending, from the security testing platform to the set of endpoints, one or more additional configuration files, each endpoint of the set of endpoints configured to perform actions described by the additional configuration files to perform a security test comprising the variant attack.
